(19) United States
(12) Patent Application Publication
(10) Pub. No.: US 2011/0036991 A1
(43) Pub. Date: Feb. 17, 2011

(54) METHOD FOR CREATING, TRAPPING AND MANIPULATING A GAS BUBBLE IN LIQUID

(75) Inventors: Sergey Oshemkov, Karmiel (IL); Lev Dvorkin, Akko (IL); Vladimir Dmitriev, Karmiel (IL)

Correspondence Address: Pearl Cohen Zedek Latzer, LLP, 1500 Broadway, 12th Floor, New York, NY, 10036, US

(73) Assignee: PIXER TECHNOLOGY LTD., Karmiel (IL)

(21) Appl. No.: 12/934,155

(22) PCT Filed: Apr. 5, 2009
(86) PCT No.: PCT/IL2009/000374

§ 371 Date: Nov. 4, 2010

Related U.S. Application Data
(60) Provisional application No. 61/042,127, filed on Apr. 3, 2008.

(51) Int. Cl. G21K 5/00

(52) U.S. Cl. 250/432 R

(57) ABSTRACT

A method for producing, trapping and manipulating a gas microbubble in liquid is disclosed. The method includes providing a pulsed laser source for generating a pulsed laser radiation and focusing optics; and focusing a pulsed laser radiation to a focal zone within the liquid, with energy exceeding the threshold of optical breakdown in the liquid at the focal zone. It is also suggested to use focusing optics to focus the laser beam to a focal point at a depth close to the compensation depth of the focusing optics for spherical aberration.

### FIELD OF THE INVENTION

The present invention relates to optical trapping. More particularly the present invention relates to a method for creating, trapping and manipulating a gas bubble in liquid.

### BACKGROUND OF THE INVENTION

Trapping and manipulating microparticles have great importance in nanotechnology and microtechnology, as well as in medical and biological applications. Trapping and manipulating particles usually involve the use of optical traps (optical or laser tweezers) imparting light pressure on a microparticle in a liquid. Despite the small force of optical tweezers in some cases it is sufficient for non-contact trapping and manipulation of cells and other microparticles.

A demonstration of the feasibility of microparticles non-damaging trapping and moving using optical tweezers was given in the paper of A. Ashkin “Acceleration and trapping of particles by radiation pressure”, Phys. Rev. Lett. 24(4), 156-159 (1970). Since that time the design of optical tweezers has been constantly improving. A number of modifications of optical tweezers have been developed and various applications have been suggested and investigated.

For example, U.S. Pat. No. 4,893,886 “Non-destructive optical trap for biological particles and method of doing same” by Ashkin et al. (Jan. 16, 1990) described method and apparatus for single beam gradient force biological particles trapping using an infrared laser. Several modes of trapping were presented.

Another U.S. Pat. No. 5,512,745 “Optical trap system and method” by Finer et al. (Apr. 30, 1996) discloses an improved design of laser tweezers. The described system includes a feedback loop to correct the off-target position, based on scattered light detection by a quadrant photodiode detector for detecting the micro particle position and an acousto-optic modulator or galvanometer mirror to change the position of the trapping beam.

Another U.S. Pat. No. 5,689,109 “Apparatus and method for the manipulation, processing and observations of small particles, in particular biological particles” by Sütze (Nov. 18, 1997) describes the modification of laser tweezers consisting of two lasers with different wavelengths. The focused radiation of the first laser forms an optical trap, and the focused radiation of the second laser is used for particles manipulation.

U.S. Pat. No. 5,953,166 “Laser trapping apparatus” by Shikano (Sep. 14, 1999) discloses a laser trapping set up for trapping an optional microparticle from a group of microparticles such as microorganisms suspended in medium

A number of patents are related to the applications of optical tweezers.

U.S. Pat. No. 6,943,062 B2 “Contaminant particle removal by optical tweezers” by Chen et al. (Sep. 13, 2005) discloses a method for removal of contamination particles from a surface without damaging the surface based on optical trapping of the particles and their moving.

U.S. Pat. No. 5,445,011 “Scanning force microscope using an optical trap” by Ghislain et al. (Aug. 29, 1995) describes the scanning force microscope where the probe is presented by an optically transparent cylinder having at least one tip on its axis, positioned and oriented by an optical trap.

U.S. Pat. No. 7,315,374 “Real-time monitoring optically trapped carbon nanotubes” by Tan et al. (Jan. 1, 2008) and U.S. Pat. No. 7,316,982 “Controlling carbon nanotubes using optical traps” by Chang (Jan. 8, 2008) describe methods and modifications of optical tweezers for manipulation of carbon nanotubes in liquids.

Some limitations of known optical tweezers include:

relatively low trapping force—usually on the piconewton (pN) level for 10 mW of the laser average power, which is not enough in some cases;

possible damage caused by laser irradiation passing in optical tweezers through the trapped microparticle;

optical tweezers provide the trapping of microparticles with a refraction index higher than that of the surrounding liquid, so low refraction index and opaque microparticles may not be trapped.

Therefore, it is desired to develop traps of a new type in order to eliminate the drawbacks of optical tweezers based on radiation pressure, especially to enable trapping of low refraction index and opaque microparticles. For example, trapping and manipulation of gas bubbles in liquid are of great importance for many applications in microtechnologies, biology and medicine.

The observation of stable trapping of micro-bubbles in liquid ethanol using a continuous wave (CW) argon laser beam was reported (B. L. Lü, Y. Q. Li, H. Ni, Y. Z. Wang “Laser-induced hybrid trap for micro-bubbles”, Appl. Phys. B 71, 801-805, 2000). A micro-bubble floating on the liquid surface was trapped by a Gaussian beam passing vertically through the medium. The explanation of the trapping effect includes the existence of light-pressure force and the fluid force induced by the convection of the liquid medium.

Another approach for optical trapping known in prior art is based on optical breakdown in liquid.

It is known that focusing of laser pulses inside a liquid causes the generation and emission of gas bubbles from the area of the focal point, due to non-linear absorption and breakdown plasma formation. These bubbles are normally non-stable cavitation bubbles having multiple oscillations. The collapsing time of a cavitation bubble t_{c} (time interval between the bubble maximum and the subsequent minimum) can be calculated from the Raleigh formula:

$${t}_{c} \approx 0.92 \sqrt{\frac{ρ}{p - {p}_{v}}} {R}_{max}$$

Where Rₘₐₓ is the maximum radius of a cavitation bubble, ρ is the liquid density, p is the ambient pressure, pᵥ is the vapor pressure.
For example, in accordance with the Raleigh formula the collapsing time of the bubble with the maximum radius of 10 um is equal to ˜0.9 μs and reduces proportionally to Rₘₐₓ.

Cavitation of bubbles causes liquid microflows formation which can be used for microparticles trapping and manipulation. Y. Jiang et. al. (Y. Jiang, Y. Matsumoto, Y. Hosokawa, et. al., “Trapping and manipulation of a single micro-object in solution with femtosecond laser-induced mechanical force”, Appl. Phys. Lett., 90, p. 061107, 2007) disclosed a method of trapping and manipulation of a micro-object by scanning femtosecond laser pulses around the microparticle to be trapped, which is ascribed to a shockwave, a cavitation bubble, and a jet flow. However this method does not allow for trapping a gas bubble in the liquid.

The way to trap a laser-induced cavitation bubble in water was described (Jing Yong Ye, Guoqing Chang, Theodore B. Norris, et al. “Trapping cavitation bubbles with a self-focused laser beam”, Optics Letters, 29, No. 18, p. 2136-2138, 2004). A homebuilt 250-kHz regeneratively amplified Ti:sapphire laser was used with an output pulse width of 100 fs and a wavelength of 793 nm. The laser beam was loosely focused (by the lens with an f-number of 15 which corresponds to the numerical aperture≈0.03) upward into a quartz cuvette containing spectrophotometric-grade purified water. Under this focusing condition, a white-light continuum and bubble generation for average laser powers above 210 mW were observed which is connected with self-focusing of the laser beam. At the same time the trapping of gas bubbles was observed. It should be outlined, that no bubbles were trapped with a downward laser beam. However it is impossible using this method to make a stable trap for a gas bubble localized in a predetermined point in the liquid using a self-focusing laser beam, and this may be because of the non-controllability of the self-focusing process. The size of the trapped gas bubble is uncontrollable too and can not be changed. The use of high average laser power above 210 mW and white light generation may cause damage of surrounding objects which significantly imparts limitations on many applications, for instance, in medicine and biology.

### SUMMARY OF THE INVENTION

There is thus provided, according to embodiments of the present invention, a method for creating, trapping and manipulating a gas microbubble in liquid. The method includes providing a pulsed laser source for generating a pulsed laser radiation and focusing optics; and focusing a pulsed laser radiation to a focal zone within the liquid, with energy exceeding the threshold of optical breakdown in the liquid at the focal zone.

Furthermore, in accordance with some embodiments of the present invention, the step of focusing the pulsed laser includes focusing the pulsed laser beam using dry focusing optics to a point in the liquid so that the depth of focal point in the liquid lies in the vicinity of the objective compensation depth for spherical aberration.

Furthermore, in accordance with some embodiments of the present invention, the focusing optics has numerical aperture in the range of 0.3-1.65.

Furthermore, in accordance with some embodiments of the present invention, the step of focusing the pulsed laser includes focusing the pulsed laser using immersion focusing optics.

Furthermore, in accordance with some embodiments of the present invention, the method includes providing a waveguide for guiding the laser beam to a remote location.

Furthermore, in accordance with some embodiments of the present invention, the pulsed laser source comprises a laser source adapted to generate laser pulses in the range of 10 fs-10 ps width and a wavelength in the range of 350 nm-1500 nm.

Furthermore, in accordance with some embodiments of the present invention, the pulsed laser source comprises a laser source generating pulses of 10 kHz-100 MHz repetition rate.

Furthermore, in accordance with some embodiments of the present invention, the method includes moving the focal zone within the liquid.

Furthermore, in accordance with some embodiments of the present invention, the step of moving the focal zone within the liquid includes:

providing a container in which the liquid is placed and repositioning system for repositioning the container; and

repositioning the container with respect to the pulsed laser beam.

Furthermore, in accordance with some embodiments of the present invention, the step of moving the focal zone within the liquid includes changing the angle of incidence of the pulsed laser beam with respect to the focusing optics.

Furthermore, in accordance with some embodiments of the present invention, the method includes using a controller to control the moving of the focal zone within the liquid.

Furthermore, in accordance with some embodiments of the present invention, the method includes modulating the energy of the pulsed laser beam.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 illustrates an arrangement for creating, trapping and manipulation of gas babble in liquid, according to an embodiment of the present invention.

FIG. 2 is a Depth-Pulse energy diagram of a micro-bubble trap existence for plotted for three objectives with different compensation depth for spherical aberration.

FIG. 3 illustrates an arrangement for creating, trapping and manipulation of gas babble in liquid, according to another embodiment of the present invention, using a guidewire to guide the laser beam to a remote location where it is focused.

### DETAILED DESCRIPTION OF PREFERRED EMBODIMENTS

According to an embodiment of the present invention, a method for creating, trapping and controlling the size of a gas bubble by focusing high repetition rate ultrafast laser pulses inside liquid, creating a stable gas microbubble of controllable size. The gas bubble is trapped in the focal point of the laser beam and may be manipulated by moving the focal point in the liquid volume.

According to another embodiment of the present invention it is possible to trap a gas bubble in liquid by focusing of the laser beam inside a bubble created by an external source, such as, for example, a pulse of another laser (not necessarily an ultrashort pulse laser), electrical discharge or an ultrasonic generator.

According to yet another embodiment of the present invention focusing optics coupled with optical waveguide for directing a laser beam may be used.

It is asserted that the generation of a stable trapped bubble according to embodiments of the present invention may be possible in a predefined window of parameters, such as, for example, laser pulse width in the range of 10 fs-10 ps, a wavelength in the range of 350 nm-1500 nm, with a pulse energy in the range of 1 nJ-10 μJ, repetition rate of pulses in the range of 10 kHz-100 mHz, numerical aperture (NA) of the focusing objective in the range of 0.3-1.65. For a stable trap creation, the focal point of the dry objective should preferably be placed in the liquid at a depth close to the compensation depth of the objective for spherical aberration. In case of focusing laser beam into the liquid through a piece of transparent material (dry focusing optics) the total beam pass in the transparent material and liquid should be so that the depth of focal point in the liquid lies in the range of the depths in the vicinity of the objective compensation depth for spherical aberration, the range depending on the pulse energy and repetition rate of laser pulses.

A stable trap may be created at any depth of focal point in liquid using immersion objectives.

It was demonstrated, that the diameter of the trapped bubble may depend on the energy of the laser pulse, so it may be possible to control the size of the bubble, just by changing the energy of the laser pulse. It was also shown that the trapped micro-bubble can be moved in the liquid volume by moving the laser beam focal point, so that 3D manipulation of a gas microbubble as well as of low index and opaque particles bonded to the gas bubble is facilitated. The created gas microbubble was found to have higher temperature than the surrounding liquid, so it can be used as a controllable heat deposition micro source in liquid.

According to embodiments of the present invention it is possible to create, trap and manipulate a controllable size gas micro bubble in liquid.

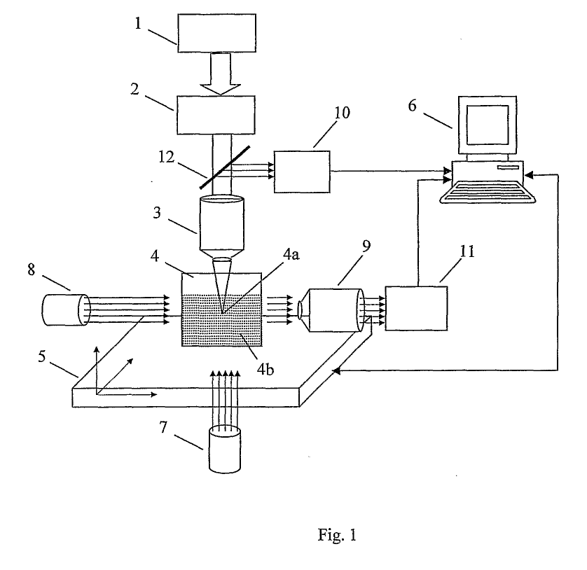

FIG. 1 illustrates an apparatus for creating, trapping and manipulating a gas microbubble, according to embodiments of the present invention.

A pulsed laser source (1) generates a pulsed laser beam that may be passed through variable attenuator (2). The beam is then focused using focusing optics, such as, for example, objective (3), into a transparent liquid within container (4) to induce a gas microbubble. In order to obtain relative motion between the focused beam and the container with liquid a repositioning system (5, e.g. X-Y-Z moving stage) is provided. This allows manipulation of the induced gas microbubble. Alternatively the focal point of the laser beam may be moved by other means (e.g. optical means, such as, for example, a scanner, or mechanical means, such as, for example, a motorized manipulator).

A controller, such as, for example, computer (6), controls the manipulation of the focal point of the beam, for example, by controlling and actuating repositioning system (5).

Two vision systems are employed, along and perpendicular to the direction of laser beam. Each vision system includes an illumination source (7, 8), focusing optics (3, 9) and an imaging sensor, such as, for example, a CCD camera (10, 11).

Observation along the laser beam is preferably performed through the same objective, as the initiating breakdown laser radiation using a dichroic mirror (12), which splits the beam reflected from the focal point.

To get a trapped gas bubble high repetition rate ultrafast laser pulses is focused inside a liquid volume using pulse energy which exceeds the threshold of the optical breakdown for that particular liquid. The rest of experimental parameters such as pulse width, NA of the focusing objective, the compensation depth of the objective for spherical aberration and the depth of the focal point in liquid should be inside the parameters window mentioned above.

As a result of breakdown of the liquid by laser pulse cavitation of gas bubble occurs. After cavitation completes the residual bubble is moved from the focal volume by a liquid flow caused by cavitation. Due to the chaotical orientation of the cavitation flow from pulse to pulse one of the residual bubbles appears to be in the focal volume at the time when one of the following laser pulses arrives, and starts to grow because of gas expansion inside the bubble caused by heating due to non-linear absorption of laser radiation in the focal volume of the objective. This local source of heating stabilizes the position of the bubble in the liquid due to pressure and heat waves propagation and their interaction with the bubble surface, allowing the following laser pulses to add more energy into the volume of the bubble which leads to further increase of the bubble diameter. Finally the size of the bubble stops growing when the heat flow out of the bubble due to thermo conductivity becomes equal to the heat flow into the bubble due to non-linear absorption.

Therefore, the mechanism of trapping may include the interaction of pressure and heat waves caused by local heating of the gas inside the bubble due to non-linear absorption of laser radiation with the wall of the bubble.

The inventors of the present invention have conducted experiments whose results are given in the examples below:

### Example 1

Laser pulses of 200 fs width and wavelength of 800 nm (1, FIG. 1) were directed through a variable attenuator (2) and were focused in distilled water by an dry objective (3) with a numerical aperture 0.55. A cuvette (4) with water (4b) was moved relative to the focal point (4a) of the objective with the help of a three-axis open frame positioning system (5), controlled by a computer (6). The setup had two vision systems working along and perpendicular to the direction of laser beam. Each vision system had an illumination source (7, 8), an objective (3, 9) and a CCD camera (10, 11). Observation along the laser beam was performed through the same objective (NA=0.55, compensation depth 6.3 mm), as the initiating breakdown laser radiation using a dichroic mirror (12). In the vision system perpendicular to the laser beam the objective (9) with NA=0.3 was used.

As it was mentioned above, typically initiation of breakdown in water by high repetition pulses is followed by residual bubbles emission from the breakdown zone at different angles and speed which is connected with chaotic orientation of cumulative microjets produced by cavitation bubbles generated by a sequence of laser pulses. Therefore, typically, laser breakdown in water by high repetition pulses involves creation of unstable cavitation bubbles and irregular emission of residual bubbles from the breakdown zone.

It was found out, that by focusing 200-fs laser pulses at 100 kHz repetition rate with 250 nJ pulse energy (the threshold of optical breakdown in our conditions was 90 nJ) by a 50×0.55 NA objective in the volume of distilled water it is possible to obtain a gas bubble and trapping it in the focal zone of the objective when the focal point of the objective is placed on the depth in the range of 5.9-6.7 mm in the water which is close to the compensation depth of the objective for spherical aberration (6.3 mm). The trapped bubble can remain trapped in a stable position for a very long, practically unlimited time. One should note that though the pulse energy exceeds the threshold of breakdown in water, no breakdown is observed during the bubble trapping. A trapped bubble can be moved in water either by changing the angle of laser beam incidence on the focusing objective or by moving the focal point relative to the water container both along the beam axis and in the lateral direction.

### Example 2

200 fs laser pulses of Ti-Sapphire laser with pulse energy of 150 nJ and 100 kHz repetition rate were focused in the water by water immersion 0.75 NA objective. In this case a stable trapped bubble was observed at any depth of the focal point of the objective in water. A trapped bubble can be moved in water either by changing the angle of laser beam incidence on the focusing objective or by moving the focal point relative to the water container both along the beam axis and in the lateral direction.

### Example 3

50 fs laser pulses of Ti-Sapphire oscillator with pulse energy of 100 nJ and 5 MHz repetition rate were focused in the water by water immersion 0.75 NA objective. In this case a stable trapped bubble was observed at any depth of the focal point of the objective in water. A trapped bubble can be moved in water either by changing the angle of laser beam incidence on the focusing objective or by moving the focal point relative to the water container both along the beam axis and in the lateral direction.

Experiments showed that the trapped bubble diameter practically does not change in the time interval between consecutive laser pulses (10 μs), i.e. it does not undergo cavitation oscillations.

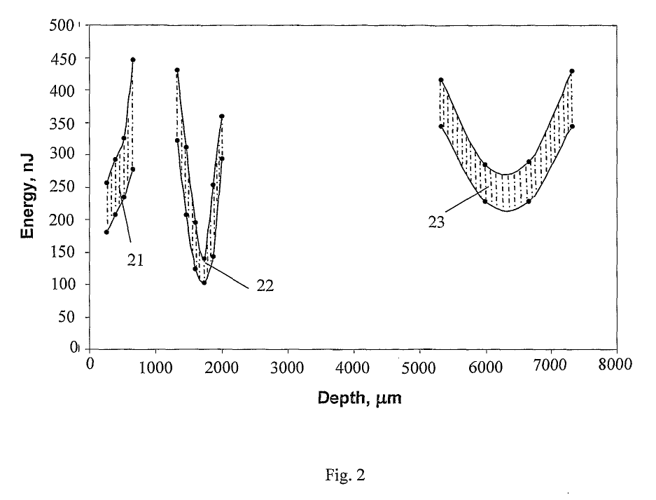

It was experimentally found out that gas bubble trapping mode occurs only when the objective focal point is moved in water at some optimal depth, for which the spherical aberration of the used objective is minimal. This is illustrated in FIG. 2, showing the diagram of the region of existence of the trap in depth—laser pulse energy coordinates for three objectives with different spherical aberration compensation depths. The first objective (region denoted 21) (50×, NA 0.5) was compensated for spherical aberration for the probe glass thickness 0.17 mm, for the second objective (region denoted 22) (50×, NA 0.6) the compensation depth for spherical aberration in glass was 1.5 mm, and for the third objective (region denoted 23) (50×, NA 0.55) it was 6.3 mm. As seen from FIG. 2, the pulse energy, necessary for bubble capture, grows significantly when moving the focal zone away from the optimum depth for all objectives, which indicates the importance of tight aberration-free beam focusing for the trap formation. FIG. 2 also shows that for the first objective at small depth of the focal point the region where the trap exists is limited. It is connected with the abrupt transition from the mode of bubble capture and trapping to the mode of liquid-bubbles jet formation, when the laser beam focusing area approaches the water-air boundary. Both modes were realized with the use of objective with NA 0.5. It was noted that switching from the bubble trapping mode to the liquid-bubbles jet formation happened simultaneously with the transition from the regime without breakdown to the regime of breakdown by every laser pulse. Breakdown plasma emission was observed in the case of a liquid-bubbles jet, while there was no such emission in the bubble capture and trapping mode.

Moving a trapped bubble in water is possible either at changing the angle of incidence of the beam on the focusing objective, or by acquiring relative movement between the focal point of the objective and the cuvette with water both along and perpendicular to the incident beam direction. Adherence of micro-particles of 3-10 μm diameter to the wall of a trapped bubble was also observed and their further moving together, which opens the possibility of manipulating micro-objects in water.

Next it was shown that the temperature of the trapped gas bubble was higher than the ambient temperature. Thus, when the trapped bubble approached a stable bubble, fixed in water on the surface of a probe glass, the expansion of the fixed bubble due to the heating of the surrounding water was observed. Therefore a trapped bubble can be used as a source for the local intra-volume water heating.

The value of the trapping force was estimated in two different ways. The trapped bubble diameter dependence on the pulse energy was investigated and it was found that under the experiment conditions the maximum diameter of the stable trapped bubble could reach 35 μm. At further energy increase and a corresponding bubble diameter growth the bubble detached and left the focal zone of the objective in the direction of the buoyancy force.

At the moment of detaching (neglecting convection flows in water) the trapping force Fₜᵣ becomes equal to buoyancy force:

Fₜᵣ=ρ·g·V,

where ρ is the density of water, V is the bubble volume, g is the gravity factor. For a 17.5 μm radius bubble the calculated trapping force is equal to 220 pN.

On the other hand, the trapping force was measured in the experiments where a trapped bubble was moved in the plane perpendicular to the laser beam. A cuvette with water was moved relative to the objective focus point at a variable speed. On reaching a certain speed the bubble detached, the trapping force Fₜᵣ became equal to the viscous drag force in the water and could be calculated according to the Stokes formula:

Fₜᵣ=6π·η·R_{b}·v,

where η is the viscosity of water, R_{b} is the radius of the bubble, V is the velocity of the bubble. At an average laser power of 20 mW the maximum velocity of the trapped bubble with a 20 μm diameter in regular distilled water appeared to be 1.2 min/s, which corresponds to a trapping force value of 200 pN, and is in good agreement with the estimated vertical trapping force. One should note, that since the experiments were performed with an average laser power of 20 mW, the specific value of the trapping force was equal to 10 pN/mW, which exceeded the corresponding value for conventional optical tweezers by two orders of magnitude.

The proposed gas bubble trap can be used for trapping and manipulating micro-objects in water, and also as a source of local heating of water and micro-objects in micro-technologies.

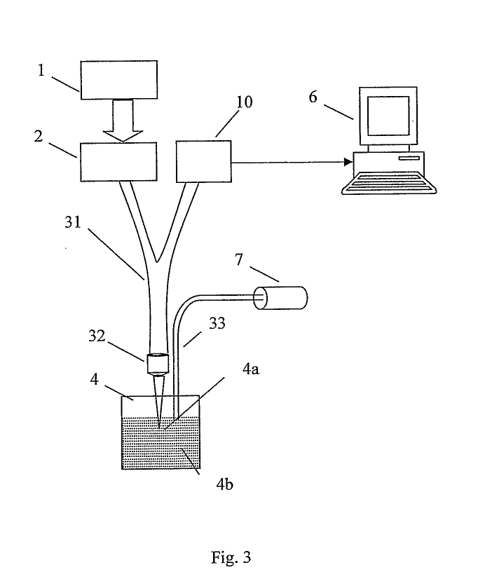

FIG. 3 illustrates an arrangement for creating, trapping and manipulation of gas babble in liquid, according to another embodiment of the present invention, using a guidewire to guide the laser beam to a remote location where it is focused.

The method according to embodiments of the present invention may be used in creating, trapping and manipulating a gas bubble within liquid at a remote location. For that aim the laser beam may be directed to the designated remote target location using a waveguide, for example optical fiber (31). Focusing optics (for example, lens 32) is provided at the distal end of the optical fiber, facilitates focusing of the emerging laser beam at a desired focal point within the liquid at the remote location. This technique may be used to create, trap and manipulate a gas bubble within a body lumen or cavity, such as, for example, a blood vessel, the bladder, or other body organ. An illumination waveguide (33) is used to direct illumination to the zone of the focal point, and inspection is carried out in parallel through waveguide (31).

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention

1. A method for creating, trapping and manipulating a gas microbubble in liquid, the method comprising:
providing a pulsed laser source for generating a pulsed laser radiation and focusing optics;
focusing a pulsed laser radiation to a focal zone within the liquid, with energy exceeding the threshold of optical breakdown in the liquid at the focal zone.

2. The method as claimed in claim 1, wherein the step of focusing the pulsed laser includes focusing the pulsed laser using dry focusing optics to a point in the liquid so that the depth of focal point in the liquid lies in the vicinity of the objective compensation depth for spherical aberration.

3. The method as claimed in claim 2, wherein the focusing optics has numerical aperture of 0.3-1.65.

4. The method as claimed in claim 1, wherein the step of focusing the pulsed laser includes focusing the pulsed laser using immersion focusing optics.

5. The method as claimed in claim 1, comprising providing a waveguide for guiding the laser beam to a remote location.

6. The method as claimed in claim 1, wherein the pulsed laser source comprises a laser source adapted to generate laser pulses of 10 fs-10 ps width and wavelength of 350 nm-1500 nm.

7. The method as claimed in claim 1, wherein the pulsed laser source comprises a laser source generating pulses of 10 kHz-100 MHz repetition rate.

8. The method as claimed in claim 1, comprising moving the focal zone within the liquid.

9. The method as claimed in claim 8, wherein the step of moving the focal zone within the liquid includes:
providing a container in which the liquid is placed and repositioning system for repositioning the container; and
repositioning the container with respect to the pulsed laser beam.

10. The method as claimed in claim 8, wherein the step of moving the focal zone within the liquid includes changing the angle of incidence of the pulsed laser beam with respect to the focusing optics.

11. The method as claimed in claim 8, including using a controller to control the moving of the focal zone within the liquid.

12. The method as claimed in claim 1, comprising modulating the energy of the pulsed laser beam.
